(19) United States
(12) Patent Application Publication
(10) Pub. No.: US 2025/0097044 A1
(43) Pub. Date: Mar. 20, 2025

(54) SYSTEM AND METHOD FOR DETECTION OF UNAUTHENTICATED USERS

(71) Applicant: TALENT UNLIMITED ONLINE SERVICES PRIVATE LIMITED, Delhi (IN)

(72) Inventors: Saurabh Tomar, Gurugram (IN); Puneet Saraswat, Agra (IN); Rahul Prasad, Gurugram (IN)

(21) Appl. No.: 18/387,060

(22) Filed: Nov. 6, 2023

(30) Foreign Application Priority Data
Sep. 18, 2023 (IN) 202311062698

(51) Int. Cl. H04L 9/32

(52) U.S. Cl. CPC H04L 9/3239; H04L 9/3297

(57) ABSTRACT

Disclosed is a system (100) including first and second processing circuitries (112 and 122). The first processing circuitry (112) generates a first hash sum using a package name and a first identifier and generates an encrypted string using the first identifier, the first hash sum, and a first timestamp. The second processing circuitry (122) receives the encrypted string and the package name from the first processing circuitry (112), extracts a second identifier, a second hash sum, and a second timestamp using the encrypted string, wherein the second hash sum is equal to the first hash sum, generates a third hash sum using the second identifier and the package name, and compare the third hash sum with the second hash sum, to generate an initiation signal.

### TECHNICAL FIELD

The present disclosure relates to user identification, and more particularly to a system and a method for detection of unauthenticated users.

### BACKGROUND

An online transaction relates to sharing information, data and asset between multiple online users. The occurrence of online transactions via network calls has drastically increased due to easy availability of internet services and advancement in technology developed towards security of the transactions.

Most of the approaches for initiation of online transactions require the users to log-in to a system deployed for transaction, that enables a trust of identification between the users. In such case, the information of identity of the user is typically shared in the form of a secure token associated with the log-in details of the user. However, the information associated with the users that are not logged-in is very limited and is typically in the form of an advertising ID. Such information, using a proxy tool is easily hackable and can be tampered by a malicious user that results in misleading identification of the user at the receiver's end. The contemporary technology fails to identify such a manipulation of information at the receiver's end efficiently, which becomes a huge problem for user identification as the count of malicious users increase.

Thus, to address the aforementioned problems, there remains a need for a technical solution to provide efficient user identification for non-logged-in users and rate limiting of malicious users.

### SUMMARY

In an aspect of the present disclosure, a system includes first processing circuitry coupled to second processing circuitry. The first processing circuitry is configured to generate a first hash sum using a package name and a first identifier, and an encrypted string using the first identifier, the first hash sum, and a first timestamp. The second processing circuitry is configured to receive the encrypted string and the package name from the first processing circuitry, extract a second identifier, a second hash sum, and a second timestamp using the encrypted string, generate a third hash sum using the second identifier and the package name, compare the third hash sum with the second hash sum, and generate an initiation signal based on the comparison. The second hash sum is equal to the first hash sum.

In some aspects, prior to the generation of the first hash sum, the first processing circuitry is configured to determine the package name, the first identifier, and the first timestamp, that are associated with a request to a transaction from the first processing circuitry to the second processing circuitry.

In some aspects, to generate the first hash sum, the first processing circuitry is configured to combine the package name and the first identifier to generate first combined data and perform hashing of the first combined data using a hashing technique.

In some aspects, to generate the encrypted string, the first processing circuitry is configured to combine the first identifier, the first hash sum, and the timestamp to generate second combined data and encrypt the second combined data using a cryptography technique.

In some aspects, to extract the second identifier, the second hash sum, and the second timestamp, the second processing circuitry is configured to decrypt the encrypted string using the cryptography technique to generate third combined data and segregate the third combined data into the second identifier, the second hash sum, and the second timestamp.

In some aspects, to generate the third hash sum, the second processing circuitry is configured to combine the second identifier and the package name to generate fourth combined data and perform hashing of the fourth combined data using the hashing technique.

In some aspects, when the third hash sum matches with the second hash sum, the initiation signal enables the second processing circuitry to determine a transaction time based on the second timestamp and compare the transaction time with a predefined threshold value. When the transaction time is less than the predefined threshold value, the second processing circuitry is configured to generate an acknowledgement signal, transmit the acknowledgement signal to the first processing circuitry, and enable the transaction from the first processing circuitry. When the transaction time is greater than or equal to the predefined threshold value, the second processing circuitry is configured to generate a first alert signal, transmit the first alert signal to the first processing circuitry, and discard the transaction from the first processing circuitry.

In some aspects, when the third hash sum is mismatched with the second hash sum, the initiation signal enables the second processing circuitry to generate a second alert signal, transmit the second alert signal to the first processing circuitry, and discard the transaction from the first processing circuitry.

In some other aspects of the present disclosure, a method includes generating, by way of first processing circuitry, a first hash sum using a package name and a first identifier. The method further includes generating, by way of the first processing circuitry, an encrypted string using the first identifier, the first hash sum, and a first timestamp. Furthermore, the method further includes receiving, by way of second processing circuitry, the encrypted string and the package name from the first processing circuitry. Furthermore, the method includes extracting, by way of the second processing circuitry, a second identifier, a second hash sum, and a second timestamp using the encrypted string, wherein the second hash sum is equal to the first hash sum. Furthermore, the method includes extracting, by way of the second processing circuitry, a third hash sum using the second identifier and the package name. Furthermore, the method includes comparing, by way of the second processing circuitry, the third hash sum with the second hash sum and generating an initiation signal based on the comparison.

### BRIEF DESCRIPTION OF DRAWINGS

The drawing/s mentioned herein disclose exemplary aspects of the present disclosure. Other objects, features, and advantages of the present disclosure will be apparent from the following description when read with reference to the accompanying drawing.

FIG. 1 is a block diagram that illustrates a system for identification of non-logged-in (unauthentic) users and rate limiting of malicious users, in accordance with an aspect of the present disclosure;

FIG. 2 is a block diagram that illustrates a first user device of the system of FIG. 1, in with an aspect of the present disclosure;

FIG. 3 is a block diagram that illustrates a second user device of the system of FIG. 1, in accordance with an aspect of the present disclosure; and

FIGS. 4A and 4B is a flowchart that illustrates a method for identification of non-logged-in users and rate limiting of malicious users, in accordance with an aspect of the present disclosure.

To facilitate understanding, like reference numerals have been used, where possible to designate like elements common to the figures.

### DETAILED DESCRIPTION OF PREFERRED ASPECTS

Various aspects of the present disclosure provide a system and a method for non-logged-in user identification and rate limiting of malicious users. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element is referred to as being “on,” “connected to,” or “coupled to” another element, it can be directly on, connected to, or coupled to the other element or intervening elements that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this patent. Rather, the inventor/inventors have contemplated that the presented subject matter might also be embodied in other ways, to include different features or combinations of features similar to the ones described in this document, in conjunction with other technologies. As mentioned, there remains a need for a technical solution for efficient identification and authentication of non-logged in users and rate limiting of malicious users. Generally, the various aspects including the example aspects relate to the system and the method for identification and authentication of non-logged-in users and rate limiting of malicious users.

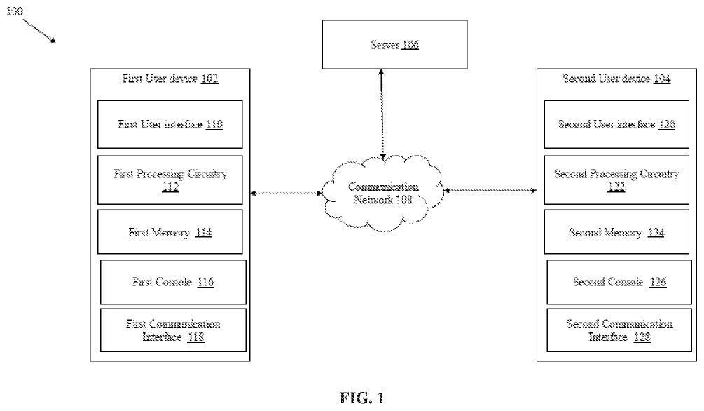

Referring initially to the drawings, FIG. 1 illustrates a block diagram of system 100 for identification and authentication of non-logged-in users and rate limiting of malicious users, in accordance with an aspect of the present disclosure. The system 100 may include a first user device 102, a second user device 104, and a server 106 coupled each other by way of a communication network 108.

The first and second user devices 102-104 may include first and second user interfaces 110 and 120, first and second processing circuitries 112 and 122, first and second memories 114 and 124, first and second consoles 116 and 126, and first and second communication interfaces 118 and 128, respectively. The first and second user interfaces 110 and 120 may include first and second input interfaces (not shown) for receiving one or more inputs from first and second user. Specifically, the first input interface may be configured to enable the first user to provide one or more inputs for a request to a transaction between the first user device 102 and the second user device 104. Specifically, the second input interface may be configured to facilitate the second user to provide one or more inputs to enable the transaction between the first user device 102 and the second user device 104. Examples of the transaction between the first user device 102 and the second user device 104 may include, but not limited to, sharing data, information, assets, and the like. Aspects of the present disclosure are intended to include or otherwise cover any type of transactions including known, related art, and/or related to later developed technologies. Examples of the first and second input interfaces may include, but are not limited to, a touch interface, a mouse, a keyboard, a motion recognition unit, a gesture recognition unit, a voice recognition unit, or the like. Aspects of the present disclosure are intended to include or otherwise cover any type of the first and second input interfaces including known, related art, and/or later developed technologies.

The first and second user interfaces 110 and 120 may further include first and second output interfaces (not shown) for displaying (or presenting) one or more outputs to the first and second users, respectively. Specifically, the first and second output interfaces may be configured to display (or present) one or more notifications generated by way of either of, an acknowledgement signal, a first alert signal, a second alert signal, and/or related to operations of the system 100 to the first and second users. Examples of the first and second output interfaces may include, but are not limited to, a digital display, an analog display, a touch screen display, a graphical user interface, a website, a webpage, a keyboard, a mouse, a light pen, an appearance of a desktop, and/or illuminated characters. Aspects of the present disclosure are intended to include and/or otherwise cover any type of the first and second output interfaces including known and/or related, or later developed technologies.

The first and second processing circuitries 112 and 122 may include suitable logic, instructions, circuitry, interfaces, and/or codes for executing various operations, such as the operations associated with the first and second user devices 102 and 104, respectively. In some aspects of the present disclosure, the first and second processing circuitries 112 and 122 may utilize one or more processors such as Arduino or raspberry pi or the like. Further, the processing circuitries 112 and 122 may be configured to control one or more operations executed by the first and second user devices 102 and 104, respectively, in response to the one or more inputs received at the first and second user interfaces 110 and 120 from the first and second users, respectively. Examples of the first and second processing circuitries 112 and 122 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), a datacentre, and the like. Aspects of the present disclosure are intended to include or otherwise cover any type of the first and second processing circuitries 112 and 122 including known, related art, and/or later developed processing units.

The first and second device memories 114 and 124 may be configured to store the logic, instructions, circuitry, interfaces, and/or codes of the processing circuitry, data associated with the first and second user devices 102 and 104, and/or data associated with the system 100. Specifically, the first and second memories 114 and 124 may be configured to store therein, at least one of, one or more instructions of the first and second processing circuitries 112 and 122, package data (i.e, data associated with a package that represents a request to the transaction between the first user device 102 and the second user device 104), encrypted data, decrypted data, data associated with one or more signals generated by the first and second processing circuitry 112 and 122, and the like. Aspects of the present disclosure are intended to include or otherwise cover any type of the data without deviating from the scope of the present disclosure. Examples of the first and second memories 114 and 124 may include, but not limited to, a Read-Only Memory (ROM), a Random-Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Aspects of the present disclosure are intended to include or otherwise cover any type of the first and second memories 114 and 124 including known, related art, and/or later developed memories.

The first and second consoles 116 and 126 may be configured as computer-executable applications, to be executed by the first and second processing circuitries 112 and 122, respectively. The one or more computer executable applications corresponding to the first and second consoles 116 and 126 may be stored in the first and second memories 114 and 124, respectively. Examples of the one or more computer executable applications may include, but are not limited to, an audio application, a video application, a social media application, a navigation application, or the like. Aspects of the present disclosure are intended to include or otherwise cover any type of the computer executable application including known, related art, and/or later developed computer executable applications.

The first and second communication interfaces 118 and 128 may be configured to enable the first and second user devices 102 and 104 to communicate with each other, and to communicate with the server 106. Examples of the first and second communication interfaces 118 and 128 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the first and second communication interfaces 118 and 128 may include any device and/or apparatus capable of providing wireless or wired communication from the first and second user devices 102 and 104, respectively, with each other and with the server 106.

The server 106 may be a network of computers, a software framework, or a combination thereof, that may provide a generalized approach to create the server implementation. Examples of the server 106 may include, but are not limited to, personal computers, laptops, mini-computers, mainframe computers, any non-transient and tangible machine that can execute a machine-readable code, cloud-based servers, distributed server networks, or a network of computer systems. The server 106 may be realized through various web-based technologies such as, but not limited to, a Java web-framework, a .NET framework, a personal home page (PHP) framework, or any web-application framework. Specifically, the server 106 may provide a centralized platform to the first and second user devices 102 and 104 to communicate with each other.

The communication network 108 may include suitable logic, circuitry, and interfaces that may be configured to provide a plurality of network ports and a plurality of communication channels for transmission and reception of either of, data, signals, instructions, information, and the like related to operations of various entities of the system 100 (such as the first and second user devices 102 and 104, and the server 106). Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 108 may be associated with an application layer for implementation of communication protocols based on one or more communication requests from the first and second user devices 102 and 104, and the server 106. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In an aspect of the present disclosure, the communication data may be transmitted or received via at least one communication channel of a plurality of communication channels in the communication network 108. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Aspects of the present disclosure are intended to include or otherwise cover any type of communication channel, including known, related art, and/or later developed technologies.

In operation, the system 100, by way of the first processing circuitry 112 of the first user device 102, may be configured to determine a package name, a first identifier, and a first timestamp, associated with a request to a transaction from the first processing circuitry 112 to the second processing circuitry 122. Upon determination of the package name, the first identifier, and the first timestamp, the system 100, by way of the first processing circuitry 112, may be configured to generate a first hash sum using the package name and the first identifier. The system 100, by way of the first processing circuitry 112 may further be configured to generate an encrypted string using the first identifier, the first hash sum, and a first timestamp. Furthermore, the system 100, by way of the first processing circuitry 112 may be configured to transmit the encrypted string to the second user device 104. Upon reception of the encrypted string, the system 100, by way of the second processing circuitry 122 of the second user device 104, may be configured to extract a second identifier, a second hash sum, and a second timestamp using the encrypted string such that the second hash sum is equal to the first hash sum. The system 100, by way of the second processing circuitry 122 may further be configured to generate the third hash sum using the second identifier and the package name. Furthermore, the system 100, by way of the second processing circuitry 122 compare the third hash sum with the second hash sum, and generate an initiation signal based on the comparison. In some aspects of the present disclosure, when the third hash sum matches with the second hash sum, the system 100, by way of the initiation signal, may enable the second processing circuitry 122 to determine a transaction time based on the second timestamp and compare the transaction time with a predefined threshold value. When the transaction time is less than the predefined threshold value, the system 100, by way of the second processing circuitry 122, may be configured to generate an acknowledgement signal, transmit the acknowledgement signal to the first processing circuitry 112, and enable the transaction from the first processing circuitry 112. When the transaction time is greater than or equal to the predefined threshold value, the system 100 by way of the second processing circuitry 122, may be configured to generate a first alert signal, transmit the first alert signal to the first processing circuitry 112, and discard the transaction from the first processing circuitry 112. In some other aspects of the present disclosure, when the third hash sum is mismatched with the second hash sum, the system 100, by way of the initiation signal, may enable the processing circuitry 122 to generate a second alert signal, transmit the second alert signal to the first processing circuitry 112, and discard the transaction from the first processing circuitry 112.

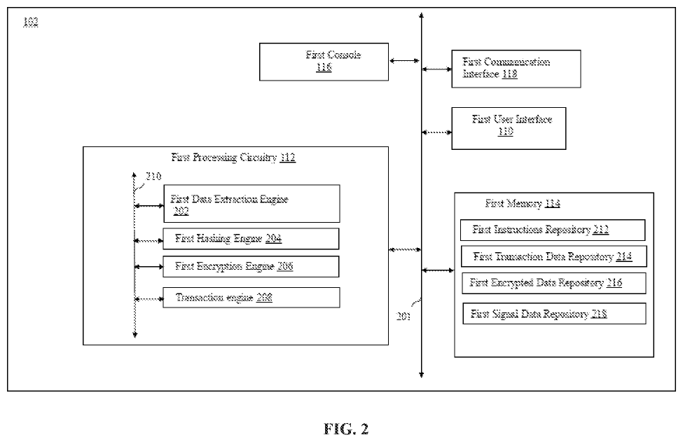

FIG. 2 is a block diagram that illustrates the first user device 102 of the system 100 of FIG. 1, in with an aspect of the present disclosure. The first user device 102 may include the first user interface 110, the first processing circuitry 112, the first memory 114, the first console 116, and the first communication interface 118. In some aspects of the present disclosure, the first user interface 110, the first processing circuitry 112, the first memory 114, the first console 116, and the first communication interface 118 may be communicatively coupled to each other by way of a first communication bus 201.

In some aspects of the present disclosure, the first processing circuitry 112 may include a first data extraction engine 202, a first hashing engine 204, a first encryption engine 206, and a transaction engine 208, that may be communicatively coupled to each other by way of a second communication bus 210.

The first data extraction engine 202 may be configured to extract (or determine) the package name, the first identifier, and the first timestamp, that are associated with the request to the transaction from the first user device 102 (by way of the first processing circuitry 112) to the second user device 104 (by way of the second processing circuitry 122). In some aspects of the present disclosure, the request to the transaction may be in a form of a package. In such a scenario, the first identifier may include an advertisement identification (i.e., advertising ID) of the transaction. Examples of the advertising ID may include, but not limited to, Google advertising ID (AAID), Identifier for Advertising (IDFA), and the like. Aspects of the present disclosure are intended to include or otherwise cover any type of advertising ID and/or identifier ID, including known, related art, and/or related to later developed technologies. The package name may be in the form of ‘a name’ or ‘a title’ of the package associated with the transaction. The first timestamp may include temporal data associated with generation of the package associated with the transaction. In some aspects of the present disclosure, the first timestamp may further include information of the lifetime of the transaction. In some other aspects of the present disclosure, the timestamp may enable generation of a token associated with the package, that may depict the lifetime (i.e., a transaction time) associated with the package (or the transaction). Upon determination of the package name, the first identifier, and the first timestamp, the first data extraction engine 202 may provide the package name and the first identifier to the first hashing engine 204.

The first hashing engine 204, may be configured to generate the first hash sum using the package name and the first identifier. In some aspects of the present disclosure, to generate the first hash sum, the first hashing engine 204 may be configured to combine the package name and the first identifier to generate first combined data. The first hashing engine 204 may further be configured to perform hashing on the first combined data using a hashing technique. Preferably, the first hashing engine 204 may use a Standard Hashing Algorithm of 256 bits (SHA-256) to perform hashing on the first combined data for generation of the first hash sum.

In some aspects of the present disclosure, the first hashing engine 204 may be configured to generate a first random string that may be cryptographically secure. The first hashing engine 204 may further be configured to add (or concatenate) the first random string to a first hashing key (that may or may not be predefined by the system 100) to generate a first concatenated hashing function. Furthermore, the first hashing engine 204 may be configured to generate the first hash sum based on the first concatenated hashing function. In some aspects of the present disclosure, the first concatenated hashing function may be stored with the first hash sum that makes the first hash sum difficult to be retrieved or changed.

Upon generation of the first hash sum, the first data extraction engine 202 may be configured to provide the first identifier and the first timestamp to the first encryption engine 206. The first hashing engine 204 may further be configured to provide the first hash sum to the first encryption engine 206.

The first encryption engine 206, upon reception of the first identifier and the first timestamp from the first data extraction engine and the first hash sum from the first hashing engine 204, may be configured to generate the encrypted string using the first identifier, the first hash sum, and the first timestamp. In some aspects of the present disclosure, to generate the first hash sum, the first encryption engine 206 may be configured combine the first identifier, the first hash sum, and the timestamp to generate second combined data. The first encryption engine 206 may further be configured to encrypt the second combined data using a cryptography technique. Preferably, the first encryption engine 206 may be configured to use Advanced Encryption Standards of 256 bits (AES-256) algorithm to encrypt the second combined data for the generation of the encrypted string. Upon generation of the encrypted string, the first encryption engine 206 may be configured to transmit (or send) the encrypted string to the second user device 104.

In some aspects of the present disclosure, when the first user device 102 receives the acknowledgement signal from the second user device 104, the transaction engine 208 may be configured to initiate the transaction from the first user device 102 to the second user device 104.

In some aspects of the present disclosure, the first memory 114 may include a first instructions repository 212, a first transaction repository 214, a first encryption data repository 216, and a first signal data repository 218. The first instructions repository 212 may be configured to store one or more instructions of the first user device 102. The first transaction repository 214 may be configured to store data and/or metadata of the transaction (such as data of the package associated with the transaction), and the like. The first encrypted data repository 216 may be configured to store the encrypted data generated by the first and second encryption engines 204 and 206. The first signal repository 218 may be configured to store therein, one or more signals generated and/or received by the first user device 102 (such as either of, the acknowledgement signal, the first alert signal, the second alert signal, and the like).

In some other aspects of the present disclosure, the server 106 may perform one or more operations of the first user device 102, as discussed hereinabove.

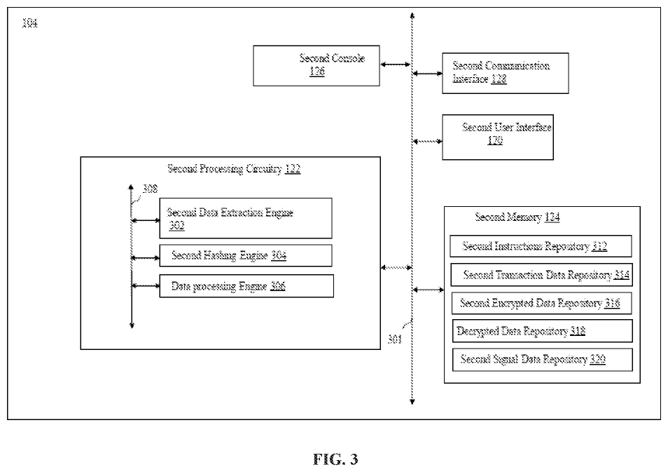

FIG. 3 is a block diagram that illustrates the second user device 104 of the system 100 of FIG. 1, in accordance with an aspect of the present disclosure.

The second user device 104 may include the second user interface 120, the second processing circuitry 122, the second memory 124, the second console 126, and the second communication interface 128. In some aspects of the present disclosure, the second user interface 120, the second processing circuitry 122, the second memory 124, the second console 126, and the second communication interface 128 may be communicatively coupled to each other by way of a third communication bus 301.

In some aspects of the present disclosure, the second processing circuitry 122 may include, a second data extraction engine 302, a second hashing engine 304, and a data processing engine 306 that may be communicatively coupled to each other by way of a fourth communication bus 308.

The second data extraction engine 308 may be configured to receive the encrypted string from the first processing circuitry 112. Upon reception of the encrypted string, the second data extraction engine 308 may be configured to extract the second identifier, the second hash sum, and the second timestamp using the encrypted string. Being encrypted by the first encryption engine 204 and hashed by the first hashing engine 206, the first hash sum remains intact in the encrypted string even when the decrypted string (specifically the first identifier or the first timestamp) is manipulated by the malicious user, and thus the second hash sum is equal to the first hash sum.

In some aspects of the present disclosure, to extract the second identifier, the second hash sum, and the second timestamp, the second data extraction engine 302 may be configured to decrypt the encrypted string using the cryptography technique to generate third combined data. Preferably, the second data extraction engine 302 may be configured to use the Advanced Encryption Standards of 256 bits (AES-256) algorithm to decrypt the encrypted string to generate the third combined data. The second data extraction engine 302 may further be configured to segregate the third combined data into the second identifier, the second hash sum, and the second timestamp. Upon segregation of the third combined data, the second data extraction engine 302 may be configured to send the second identifier to the second hashing engine 304. The second data extraction engine 302 may further be configured to send the second hash sum and the second timestamp to the data processing engine 306.

Upon reception of the second identifier from the second data extraction engine 302, the second hashing engine 304 may be configured to receive the package name from the first processing circuitry 112. The second hashing engine 304 may further be configured to generate the third hash sum using the second identifier and the package name. In some aspects of the present disclosure, to generate the third hash sum, the second hashing engine 304 may be configured to combine the second identifier and the package name to generate fourth combined data. The second hashing engine 304 may further be configured to perform hashing on the fourth combined data using the hashing technique. Preferably, the second hashing engine 304 may use the Standard Hashing Algorithm of 256 bits (SHA-256) to encrypt the fourth combined data for generation of the third hash sum.

In some aspects of the present disclosure, the second hashing engine 304 may be configured to generate a second random string that may be cryptographically secure. The second hashing engine 304 may further be configured to add (or concatenate) the second random string to a second hashing key (that may or may not be predefined by the system 100) to generate a second concatenated hashing function. Furthermore, the second hashing engine 304 may be configured to generate the third hash sum based on the second concatenated hashing function. In some aspects of the present disclosure, the second concatenated hashing function may be stored with the third hash sum that makes the second hash sum difficult to be retrieved or changed.

Upon generation of the third hash sum, the second hashing engine 304 may be configured to send the third hash sum to the data processing engine 306.

Upon reception of the second hash sum and the second time stamp from the second data extraction 302, and the third hash sum from the second hashing engine 304, the data processing engine 306 may be configured to compare the third hash sum with the second hash sum to generate the initiation signal.

In some aspects of the present disclosure, when the third hash sum matches with the second hash sum, the data processing engine 306, by way of the initiation signal, may determine the transaction time based on the second timestamp. The data processing engine 306 may further be configured to compare the transaction time with a predefined threshold value. In some aspects of the present disclosure, when the transaction time is less than the predefined threshold value, the data processing engine 306 may be configured to generate the acknowledgement signal, transmit the acknowledgement signal to the first user device 102, and enable the transaction from the first user device 102. In some other aspects of the present disclosure, when the transaction time is greater than or equal to the predefined threshold value, the data processing engine 306 may be configured to generate the first alert signal, transmit the first alert signal to the first user device 102, and discard the transaction from the first user device 102.

In some other aspects of the present disclosure, when the third hash sum is mismatched with the second hash sum, the data processing engine 306, by way of the initiation signal, may be configured to generate the second alert signal, transmit the second alert signal to the first user device 102, and discard the transaction from the first user device 102.

In some aspects of the present disclosure, the second memory 124 may include a first instructions repository 312, a second transaction repository 314, a second encryption data repository 316, decrypted data repository 318, and a second signal data repository 320. The second instructions repository 312 may be configured to store one or more instructions of the second user device 104. The second transaction repository 314 may be configured to store data and/or metadata of the transaction (such as data of the package associated with the transaction) received from the first user device 102, and the like. The second encrypted data repository 316 may be configured to store the hashed data generated by the second hashing engine 304. The decrypted data repository 318 may be configured to store the decrypted (or extracted) data generated by the data extraction engine 302. The first signal repository 218 may be configured to store therein one or more signals generated by the data processing engine 306 (such as either of, the acknowledgement signal, the first alert signal, the second alert signal, and the like).

In some other aspects of the present disclosure, the server 106 may perform one or more operations of the second user device 104, as discussed hereinabove.

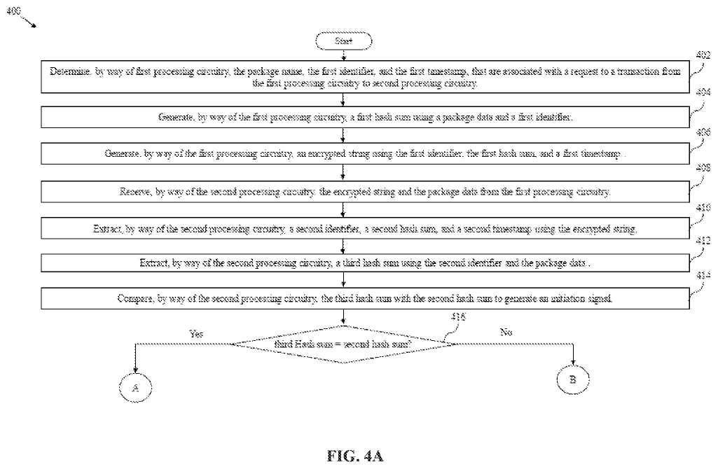

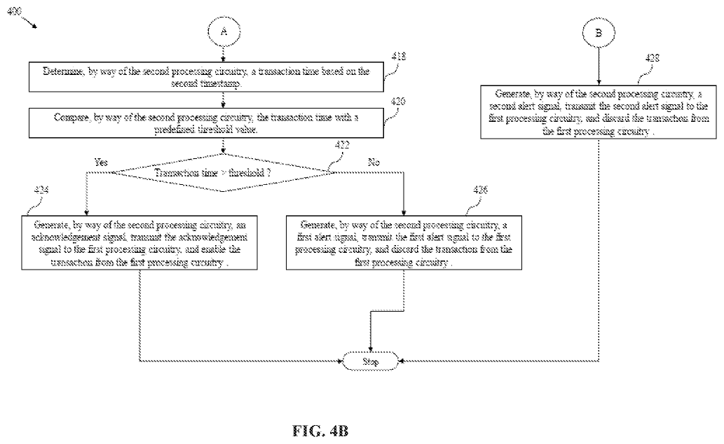

FIG. 4 is a flowchart that illustrates a method 400 for identification of non-logged-in users and rate limiting of malicious users, in accordance with an aspect of the present disclosure.

At step 402, the system 100, by way of the first processing circuitry 112 may determine the package name, the first identifier, and the first timestamp, that are associated with the request to the transaction from the first processing circuitry 112 to the second processing circuitry 122.

At step 404, the system 100, by way of the first processing circuitry 112 may generate the first hash sum using the package name and the first identifier.

In some aspects of the present disclosure, to generate the first hash sum, the system 100, by way of the first processing circuitry 112 may combine the package name and the first identifier to generate the first combined data and encrypt the first combined data using the hashing technique.

At step 406, the system 100, by way of the first processing circuitry 112, may generate the encrypted string using the first identifier, the first hash sum, and the first timestamp.

In some aspects of the present disclosure, to generate the encrypted string, the system 100, by way of the first processing circuitry 112 may combine the first identifier, the first hash sum, and the timestamp to generate the second combined data and encrypt the second combined data using the cryptography technique.

At step 408, the system 100, by way of the second processing circuitry 122, may receive the encrypted string and the package name from the first processing circuitry 112.

At step 410, the system, by way of the second processing circuitry 122, may extract the second identifier, the second hash sum, and the second timestamp using the encrypted string such that the second hash sum is equal to the first hash sum.

In some aspects of the present disclosure, to extract the second identifier, the second hash sum, and the second timestamp, the system 100, by way of the second processing circuitry 122 may decrypt the encrypted string using the cryptography technique to generate the third combined data and segregate the third combined data into the second identifier, the second hash sum, and the second timestamp.

At step 412, the system 100, by way of the second processing circuitry 122, may generate a third hash sum using the second identifier and the package name.

In some aspects of the present disclosure, to generate the third hash sum, the system 100, by way of the second processing circuitry may combine the second identifier and the package name to generate the fourth combined data and encrypt the fourth combined data using the hashing technique.

At step 414, the system 100, by way of the second processing circuitry 122, may compare the third hash sum with the second hash sum, to generate the initiation signal.

At step 416, when the third hash sum is matched with the second hash sum, the system 100 proceeds to step 418, else when the third hash sum is mismatched with the second hash sum, the system 100 proceeds to step 428.

At step 418, when the third hash sum is matched with the second hash sum, the system 100, by way of the second processing circuitry 122, may determine the transaction time based on the second timestamp.

At step 420, the system 100, by way of the second processing circuitry 122, may further compare the transaction time with the predefined threshold value.

At step 422, when the transaction time is less than the predefined threshold value, the system 100 proceeds to step 424, else when the transaction time is greater than or equal to the predefined threshold value, the system 100 proceeds to step 426.

At step 424, when the transaction time is less than the predefined threshold value, the system 100, by way of the second processing circuitry 122, may generate the acknowledgement signal, transmit the acknowledgement signal to the first user device 102, and enable the transaction from the first user device 102 (by way of the first processing circuitry 112).

At step 426, when the transaction time is greater than or equal to the predefined threshold value, the system 100, by way of the second processing circuitry 122, may generate the first alert signal, transmit the first alert signal to the first user device 102, and discard the transaction from the first user device 102.

At step 428, when the third hash sum is mismatched with the second hash sum, the system 100, by way of the second processing circuitry 122, may generate the second alert signal, transmit the second alert signal to the first user device 102, and discard the transaction from the first user device 102.

As mentioned hereinabove, the contemporary systems lack a technical solution to provide efficient user identification for non-logged-in users and rate limiting of malicious users. The system 100 by way of the method 400 provide efficient identification and authentication of non-logged in users and rate limiting of malicious users. The system 100 provides a two layered security (i.e., by the hashing technique and the encryption technique) at the native side of the first user device 102, that such that the first security layer enables generation of the first hash at the native side of the first user device 102, and the second security layer generates the encrypted string to be transferred. A cryptographically secure random string is added prior to generation of the first hash sum by the first hashing engine 206 that may be stored with the first hash sum that makes it difficult for an attacker to know the original plaintext without having access to both sources. Being encrypted by the first encryption engine 204 and hashed by the first hashing engine 206, the first hash sum remains intact in the encrypted string even when the decrypted string (specifically the first identifier or the first timestamp) is manipulated by the malicious user, and thus the second hash sum is equal to the first hash sum. When the malicious user manipulates the identifier data associated with the transaction, the hash value remains the same, however the encrypted string is altered. In such a scenario, the system 100 provides extraction of the second hash, the second timestamp, and the second identifier by decryption of the encrypted string data. The system 100 further generates the third hash from the second identifier and the packet name. Further based on the comparison of the second hash and the third hash, and the transaction time with the predefined threshold value, the system 100 provides an efficient way to identify malicious users and thus rate limit transactions from the malicious users.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each aspect. Rather, as the following aspects reflect, inventive aspects lie in less than all features of a single foregoing disclosed aspect, configuration, or aspect. Thus, the following aspects are hereby incorporated into this Detailed Description, with each aspect standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those disclosed, whether or not such alternate, interchangeable and/or equivalent structures, functions, ranges or steps are disclosed herein, and without intending to publicly dedicate any patentable subject matter.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential.

Certain terms are used throughout the following description and aspects to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure.

We claim:

1. A system (100) comprising:
first processing circuitry (112) configured to (i) generate a first hash sum using a package name and a first identifier and (ii) generate an encrypted string using the first identifier, the first hash sum, and a first timestamp; and
second processing circuitry (122) configured to (i) receive the encrypted string and the package name from the first processing circuitry (112), (ii) extract a second identifier, a second hash sum, and a second timestamp using the encrypted string, wherein the second hash sum is equal to the first hash sum, (iii) generate a third hash sum using the second identifier and the package name (iv) compare the third hash sum with the second hash sum, and (v) generate an initiation signal based on the comparison.

2. The system (100) as claimed in claim 1, wherein, prior to the generation of the first hash sum, the first processing circuitry (112) is configured to determine the package name, the first identifier, and the first timestamp, that are associated with a request to a transaction from the first processing circuitry (112) to the second processing circuitry (122).

3. The system (100) as claimed in claim 1, wherein, to generate the first hash sum, the first processing circuitry (112) is configured to (i) combine the package name and the first identifier to generate first combined data and (ii) perform hashing of the first combined data using a hashing technique.

4. The system (100) as claimed in claim 1, wherein, to generate the encrypted string, the first processing circuitry (112) is configured to (i) combine the first identifier, the first hash sum, and the timestamp to generate second combined data and (ii) encrypt the second combined data using a cryptography technique.

5. The system (100) as claimed in claim 1, wherein, to extract the second identifier, the second hash sum, and the second timestamp, the second processing circuitry (122) is configured to (i) decrypt the encrypted string using the cryptography technique to generate third combined data and (ii) segregate the third combined S data into the second identifier, the second hash sum, and the second timestamp.

6. The system (100) as claimed in claim 1, wherein, to generate the third hash sum, the second processing circuitry (122) is configured to (i) combine the second identifier and the package name to generate fourth combined data and (ii) perform hashing of the fourth combined data using the hashing technique.

7. The system (100) as claimed in claim 1, wherein, when the third hash sum matches with the second hash sum, the initiation signal enables the second processing circuitry (122) to (i) determine a transaction time based on the second timestamp and (ii) compare the transaction time with a predefined threshold value, wherein, when the transaction time is less than the predefined threshold value, the second processing circuitry (122) is configured to generate an acknowledgement signal, transmit the acknowledgement signal to the first processing circuitry (112), and enable the transaction from the first processing circuitry (112), and wherein, when the transaction time is greater than or equal to the predefined threshold value, the second processing circuitry (122) is configured to generate a first alert signal, transmit the first alert signal to the first processing circuitry (112), and discard the transaction from the first processing circuitry (112).

8. The system (100) as claimed in claim 1, wherein, when the third hash sum is mismatched with the second bash sum, the initiation signal enables the second processing circuitry (122) to (i) generate a second alert signal, (ii) transmit the second alert signal to the first processing circuitry (112), and (iii) discard the transaction from the first processing circuitry (112).

9. A method (400) comprising:
generating, by way of first processing circuitry (112), a first hash sum using a package name and a first identifier;
generating, by way of the first processing circuitry (112), an encrypted string using the first identifier, the first hash sum, and a first timestamp;
receiving, by way of second processing circuitry (122), the encrypted string and the package name from the first processing circuitry (112);
extracting, by way of the second processing circuitry (122), a second identifier, a second hash sum, and a second timestamp using the encrypted string, wherein the second hash sum is equal to the first hash sum;
generating, by way of the second processing circuitry (122), a third hash sum using the second identifier and the package name;
comparing, by way of the second processing circuitry (122), the third hash sum with the second hash sum; and
generating an initiation signal based on the comparison.

10. The method (400) as claimed in claim 9, wherein, prior to generating the first hash sum, the method (400) comprising, determining, by way of the first processing circuitry (112), the package name, the first identifier, and the first timestamp, that are associated with a request to a transaction from the first processing circuitry (112) to the second processing circuitry (122).

11. The method (400) as claimed in claim 9, wherein, for generating the first hash sum, the method (400) comprising (i) combining, by way of the first processing circuitry (112), the package name and the first identifier to generate first combined data and (ii) hashing, by way of the first processing circuitry (112), the first combined data using a hashing technique.

12. The method (400) as claimed in claim 9, wherein, for generating the encrypted string, the method (400) comprising (i) combining, by way of the first processing circuitry (112), the first identifier, the first hash sum, and the timestamp to generate second combined data and (ii) encrypting, by way of the first processing circuitry (112), the second combined data using a cryptography technique.

13. The method (400) as claimed in claim 9, wherein, for extracting the second identifier, the second hash sum, and the second timestamp, the method (400) comprising (i) decrypting, by way of the second processing circuitry (122), the encrypted string using the cryptography technique to generate third combined data and (ii) segregating, by way of the second processing circuitry (122), the third combined data into the second identifier, the second hash sum, and the second timestamp.

14. The method (400) as claimed in claim 9, wherein, for generating the third hash sum, the method (400) comprising (i) combining, by way of the second processing circuitry (122), the second identifier and the package name to generate fourth combined data and (ii) hashing, by way of the second processing circuitry (122), the fourth combined data using the hashing technique.

15. The method (400) as claimed in claim 9, wherein, when the third hash sum matches with the second hash sum, the method (400) comprising enabling, the second processing circuitry (122) by way of the initiation signal for (i) determining a transaction time based on the second timestamp and (ii) comparing the transaction time with a predefined threshold value, wherein, when the transaction time is less than the predefined threshold value, the method (400) comprising generating, by way of the second processing circuitry (122), an acknowledgement signal, transmitting, by way of the second processing circuitry (122) the acknowledgement signal to the first processing circuitry (112), and enabling, by way of the second processing circuitry (122) the transaction from the first processing circuitry (112), wherein, when the transaction time is greater than or equal to the predefined threshold value, the method (400) comprising generating a first alert signal by way of the second processing circuitry (122), transmitting, by way of the second processing circuitry (122), the first alert signal to the first processing circuitry (112), and discarding, by way of the second processing circuitry (122), the transaction from the first processing circuitry (112).

16. The method (400) as claimed in claim 9, wherein, when the third hash sum is mismatched with the second hash sum, the method (400) comprising enabling, the second processing circuitry (122), by way of the initiation signal for (i) generating a second alert signal, (ii) transmitting the second alert signal to the first processing circuitry (112), and (iii) discarding the transaction from the first processing circuitry (112).
